(19) United States
(12) Patent Application Publication
(10) Pub. No.: US 2016/0332654 A1
(43) Pub. Date: Nov. 17, 2016

(54) CHILD TRANSPORTER

(71) Applicant: SIMON LANGHAM LIMITED, Bath, Somerset (GB)

(72) Inventor: Simon Nicholas LANGHAM, Bath (GB)

(21) Appl. No.: 15/039,016

(22) PCT Filed: Nov. 20, 2014
(86) PCT No.: PCT/GB2014/000480

§ 371 Date: May 24, 2016

(30) Foreign Application Priority Data
Nov. 24, 2013 (GB) 1320703.0

(51) Int. Cl. B62B 7/02; B62B 9/20; B62B 7/04

(52) U.S. Cl. CPC B62B 7/02; B62B 7/048; B62B 9/20

(57) ABSTRACT

A child transporter comprises a wheel having an axle, a seat located directly above the wheel for supporting the child, at least one footrest for supporting the child's feet such that, in use, the child straddles the wheel, and a handle extending away from the wheel so as to be graspable by an adult. The seat and footrest are positioned so that the child's weight is substantially over the central axle. This makes the child transporter easy to control from the point of view of tipping sideways, pushing forwards and steering at walking pace. At higher speeds, such as jogging and walking paces, the child transporter becomes even easier to control. This allows an adult to participate in activities such as walking or jogging, at speed or over rough ground, without carrying the child but whilst maintaining proper supervision over the child.

### BACKGROUND

Children are commonly transported in pushchairs or buggies. For many purposes, such transporters are perfectly adequate but they can be bulky and are not easily manoeuvrable. They can be difficult to navigate through small gaps, into small spaces or crowded areas, or to lift over obstacles. Moreover, these transporters do not perform well when pushed at speed or over rough ground, resulting in an uncomfortable ride for the child and, in some circumstances, causing damage to the pushchair or buggy.

It is becoming desirable to include children in physical activities such as jogging, running or hill-walking. However, the physical weight of a child of more than a few months old can preclude the possibility of the child being carried in a sling or backpack-type carrier during such activities. If the child is not carried, the lack of physical strength of the child may prevent the activity from being continued for as long as is desired by the child's parent, carer or guardian.

There is a need for a lightweight, portable, child transporter which can be used to transport a child over rough ground and/or at speed so that the child can participate in activities such as jogging, running or hill-walking undertaken by the child's parent, carer or guardian. There is also a need for a child transporter which is controllable and highly manoeuvrable by an adult walking or running over rough terrain so that the child can accompany the adult during such activities without needing to be carried. Ideally, the transporter itself needs to be transportable.

Child transporters have been proposed in the past. Examples are shown in DE 296 03 016 U1, DE 85 27 278 U1, EP 1 582 433 A1 and U.S. Pat. No. 5,511,802. However, in all of these prior art documents, the child transporter carries the child in such a way that the child's weight is borne, at least in part, by the child's parent, carer or guardian. This makes the child transporter more arduous to use than it need be. If the child transporter is arduous to use, the parent, carer or guardian may be reluctant to use the child transporter or, when he or she does use it, may not push the child transporter as far or as fast as the child would like to go.

### SUMMARY

The present application describes a child transporter comprising a wheel having an axle, a seat located directly above the wheel for supporting the child, at least one footrest for supporting the child's feet such that, in use, the child straddles the wheel, and a handle extending away from the wheel so as to be graspable by an adult. Preferably, the wheel forms the only point of contact with the ground when the child transporter is in use. This arrangement allows the child to sit astride the single wheel, but with the accompanying adult controlling the speed of forward movement, the balance and the steering of the transporter. The child's centre of gravity is positioned directly over the wheel, ideally passing substantially through the axle of the wheel, so that the force required to steer and balance the child transporter is minimised. At walking speed, the adult is able to steer and balance the transporter. At jogging speed, the gyroscopic effect of the rotating wheel keeps the wheel upright and the adult needs only to steer the transporter. The transporter is therefore highly manoeuvrable and controllable by the adult which makes the transporter suitable for use over rough terrain and at speed. Allowing the weight of the child to be carried by a suitable transporter means that the adult can take part in physical activities without carrying the child, which in turn allows the adult to be physically active for longer whilst maintaining appropriate supervision and control of the child. Such a transporter is also suitable for use in crowded areas such as towns or shops.

In some embodiments, the handle is collapsible and/or foldable and, more preferably, the handle forms a carrying handle for the child transporter when the handle is in a collapsed or folded position. This makes transportation and storage of the child transporter easier and more convenient than would be the case with a fixed handle.

In some embodiments, the child transporter includes at least one stabilising wheel connected to the handle such that, in use, movement of the handle in a direction perpendicular to the ground determines whether or not the at least one stabilising wheel contacts the ground. This allows the adult the option of using the stabilising wheel or wheels to make it easier to control the child transporter at lower speeds, particularly when travelling over smooth surfaces such as roads or pavements. The additional stability provided by the stabiliser wheel or wheels decreases the amount of effort required to maintain the child transporter in an upright position, particularly if the child being transported moves his or her weight from side to side.

### BRIEF DESCRIPTION OF THE DRAWINGS

Further preferred and advantageous features will be explained and become apparent with reference to the following specific embodiments of the disclosed child transporter, in which:

FIG. 1 is a perspective view a child transporter according to various embodiments described herein;

FIG. 2 is a side view of the child transporter shown in FIG. 1;

FIG. 3 is a front view of the child transporter shown in FIG. 1;

FIG. 4 is a plan view of the child transporter shown in FIG. 1;

FIGS. 5(a) to (d) show alternative designs of the handle of the child transporter shown in FIG. 1;

FIGS. 6(a) to (e) illustrate alternative mechanisms by which the handle of the child transporter of FIG. 1 can be made collapsible and/or foldable;

FIGS. 7(a) to (d) show alternative designs of handgrip of the child transporter shown in FIG. 1;

FIGS. 8(a) to (c) illustrate how the handle of the child transporter shown in FIG. 1 can be used as a carry handle for carrying the child transporter;

FIG. 9 illustrates the child transporter shown in FIG. 1 in use;

FIGS. 10(a) to (c) show alternative designs for the side panels of the child transporter shown in FIG. 1;

FIGS. 11(a) and 11(b) show a child transporter according to various embodiments described herein;

FIG. 12 is a perspective view of an alternative wheel suitable for use in the child transporter shown in FIG. 1;

FIG. 13 is a perspective view of a child transporter according to various embodiments described herein;

FIGS. 14 and 15 are side and front views respectively of the child transporter shown in FIG. 13; and

FIGS. 16(a) and 16(b) illustrate the child transporter shown in FIGS. 13 to 15 in use.

### DETAILED DESCRIPTION

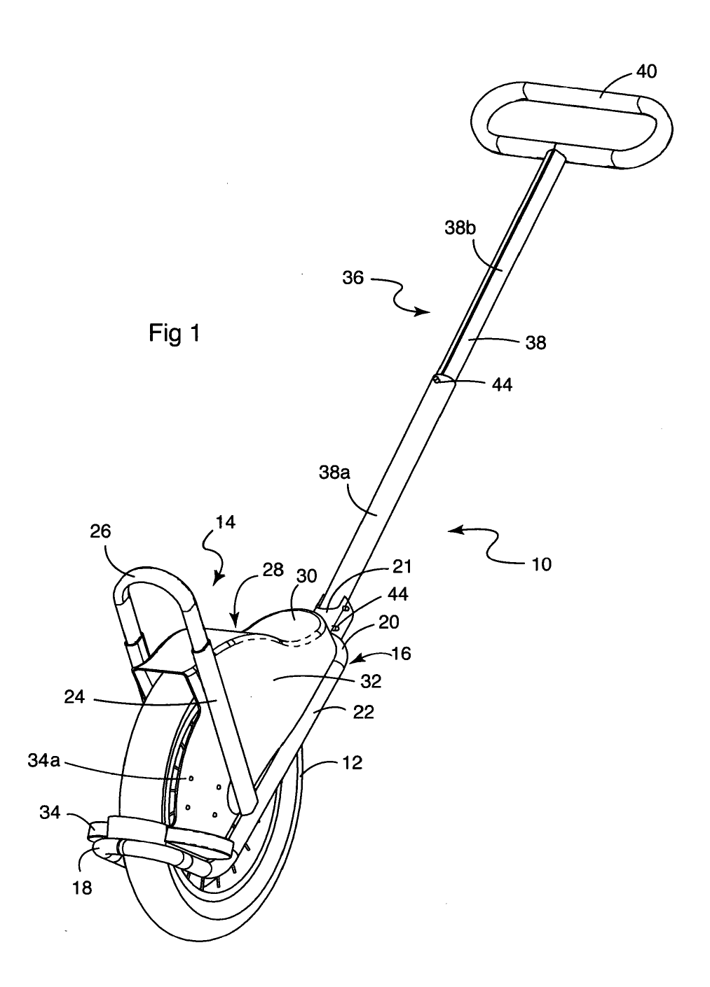

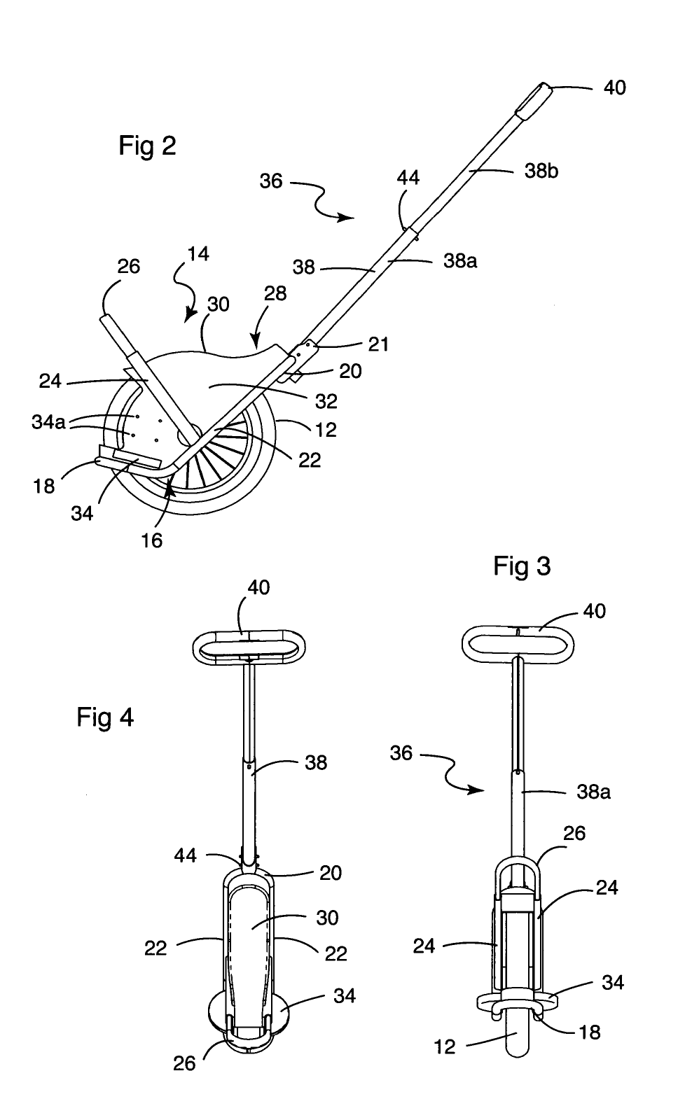

The child transporter 10 shown in FIGS. 1 to 4 comprises a wheel 12 which is rotatable about a central axle (not shown). A seat assembly 14 is located so as to enclose an upper part of the wheel 12. The seat assembly 14 comprises a frame 16 which includes a first U-shaped portion 18 extending generally around a front part of the wheel 12, a second U-shaped portion 20 extending generally around an upper, rear part of the wheel 12, and first side portions 22 extending between the first and second U-shaped portions 18, 20. Second side portions 24 extend from the first side portions 22 towards an upper front part of the wheel 12 and a handgrip 26 is provided at the upper ends of the second side portions 24. The handgrip 26 is located in front of the central axle of the wheel 12. The central axle of the wheel 12 extends between the first side portions 22 so as to allow the wheel 12 to rotate freely.

The seat assembly 14 also comprises a seat 28 which is provided on and supported by the frame 16. The seat 28 comprises a seat portion 30 and two side panels 32. The seat portion 30 extends across the wheel 12 so that the seat portion 30 projects beyond the extremities of the wheel 12 on either side thereof The seat portion 30 extends between the second U-shaped portion 20 and the handgrip 26 and is shaped so as to allow a child to sit comfortably thereon whilst allowing the wheel 12 to rotate beneath it. The shape of the seat portion 30 is contoured so that, if a younger child is seated on the child transporter (10), the child can comfortably sit in a forward position whilst, if an older child is to be transported, that child can sit further back on the seat portion (30). The side panels 32 extend downwardly from the seat portion 30 towards the first side portions 22, extending forwardly as far as the first U-shaped portion 18. The side panels 32 are generally planar to ensure that rotation of the wheel 12 is not inhibited.

Footrests 34 are provided on the seat assembly 14. The footrests 34 extend outwardly from the side panels 32, again without interfering with the rotation of the wheel 12. In the embodiment shown in FIGS. 1 to 4, the footrests 34 are positioned so that they are located below the central axle of the wheel 12. However, the position of the footrests 34 is adjustable as will be explained below.

A handle 36 extends rearwardly from the seat assembly 14 and includes a longitudinal portion 38 and a transverse portion 40. The length of the longitudinal portion 38 is such that, when the child transporter 10 is in use, the transverse portion 40 is conveniently graspable by an adult so that the child transporter 10 can be pushed along the ground. In the embodiment shown, the transverse portion 40 is located approximately 1100 mm from the central axis of the wheel 12, although this distance can be varied between 990 mm and 1300 mm depending upon the height of the adult who will be using the child transporter 10 to transport a child. The transverse portion 40 extends to either side of the longitudinal portion 38 and is appropriately shaped to allow the transverse portion 40 to be grasped with both hands by an adult.

The longitudinal portion 38 of the handle 36 is constructed so that the handle 36 can be rotated with respect to the seat assembly 14 and collapsed so as to facilitate transport and storage. In the embodiment shown in FIG. 1, the longitudinal portion 38 comprises a first section 38a and a second section 38b which have relative diameters such that the second sections 38b is able to slide telescopically inside the first section 38a. Sprung pins 44, of the type commonly used in tent poles, are provided between the first and second section 38a, 38b and between the first section 38a and a neck 21 projecting outwardly from the second U-shaped portion 20 to which the first section 38a is rotatably attached. When the sprung pins 44 are operational, the first section 38a is held firmly in position on the neck 21 and the second section 38b is held firmly in an extended position with respect to the first section 38a—as shown in FIG. 1. When the pins 44 are depressed, the second section 38b can be slid telescopically inside the first section 38a and the first section 38a can be rotated with respect to the neck 21 of the seat assembly 14. This allows the handle 36 to be collapsed for transport and storage.

The wheel 12 shown in FIG. 1 has a diameter of approximately 350 mm. However, the diameter of the wheel 12 can be selected according to the size of the child to be transported, or the terrain across which the transporter is intended to be moved. It is expected that the diameter of the wheel 12 will normally lie within the range of 300 mm to 400 mm but a diameter of anywhere in the range 250 mm to 500 mm is possible. The wheel 12 can be solid but is preferably fitted with a tyre to increase comfort. The tyre can be of solid rubber or inflatable.

As mentioned above, the footrests 34 are adjustable so that they can be positioned in any one of a number of different positions (for example, three) with respect to the seat portion 30. In the embodiment shown in FIGS. 1 to 4, pairs of holes 34a are provided in each side panel 32 and corresponding pegs (not shown) are provided on the footrests 34. This allows the footrests 34 to be placed easily into the desired position. Alternative adjustment means will be apparent to a skilled reader.

The child transporter 10 shown in FIGS. 1 to 4 is used in the following manner. First, the handle 36 is put into its extended position by rotating the first section 38a with respect to the seat assembly 14 and then sliding the second section 38b outwardly until the sprung pins 44 between the neck 21 and the first section 38a and between the first and second sections 38a, 38b come into operation and hold the said sections 38a, 38b firmly in the extended position. The footrests 34 are placed in the correct position according to the length of the legs of the child to be carried on the child transporter 10. An adult takes hold of the transverse portion 40 of the handle 36 to hold the child transporter 10 in an immobile position.

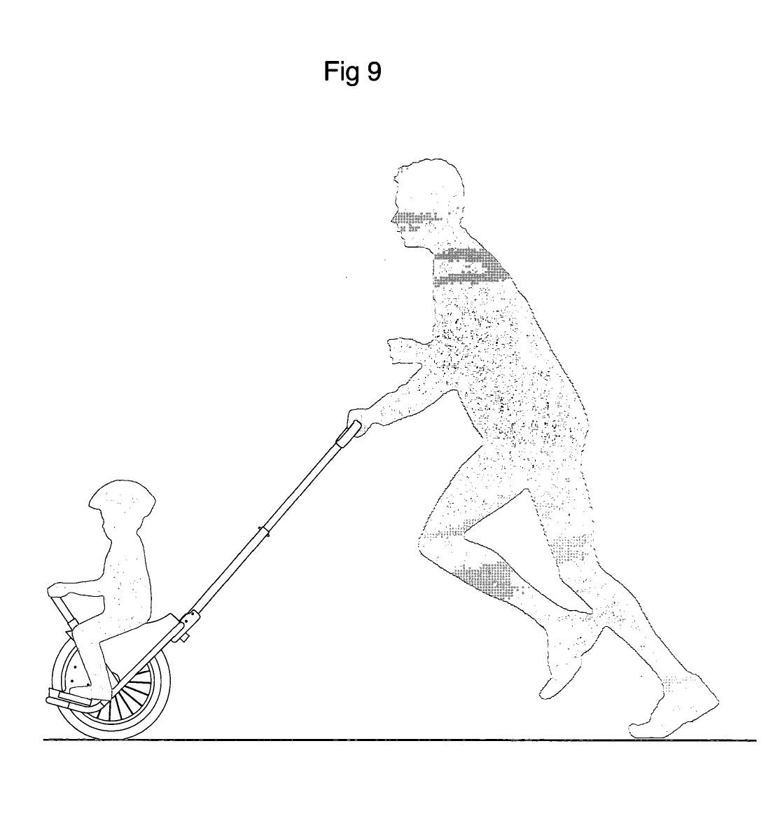

The child to be carried is then allowed to sit on the seat portion 30. The child grasps the handgrip 26 and places his or her feet on the footrests 34. The position of the child is such that the child straddles the wheel 12 with his or her bottom sitting on the seat portion 30 and his or her legs positioned on either side thereof outside the side panels 32. The side panels 32 prevent the child's legs, feet or clothing from coming into contact with the wheel 12. The arrangement just described is illustrated in FIG. 9. In this position, the adult is able to walk forwards with both hands on the transverse portion 40. The child is seated such that his or her centre of gravity is over—or very nearly so—the central axle of the wheel 12. This makes it relatively easy for the adult to counteract any tipping forces created by the child moving from side to side. The single wheel 12, which forms the only point of contact with the ground, ensures that the adult can use the handle 36 to steer with no difficulty.

It is also possible for the adult to push the child transporter 10 forwards at a pace which is faster than walking pace. Jogging or running paces are easily possible. As the speed of rotation of the wheel 12 increases, so does the gyroscopic effect tending to keep the wheel 12 in an upright orientation. This reduces the force needed to be applied by the adult to overcome any tipping forces and thus allows the adult to release one hand from the transverse portion 40 if desired. The remaining hand is moved to the centre of the transverse portion 40. This ensures that the adult remains in control of the push force being applied to the child transporter 10 and any steering which is required. With only one hand being needed for effective control of the child transporter 10, the adult is free to perform extensive periods of jogging or running over rough terrain whilst maintaining appropriate control and supervision of the child.

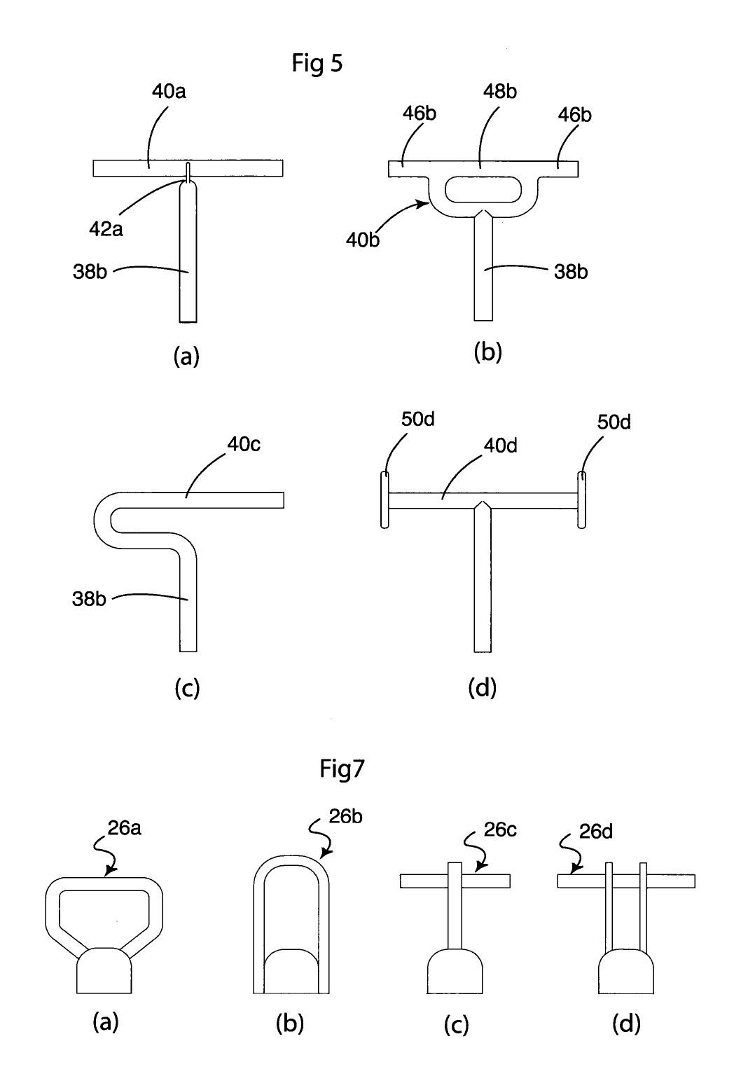

The child transported of the present application is not limited to the embodiment described in detail above. Various changes and alterations can be made without departing from the scope of the invention. For example, the shape of the distal end of the handle 36 can be varied in many different ways, some examples of which are shown in FIGS. 5(a) to 5(d). In the first of these, shown in FIG. 5(a), the transverse portion 40a consists of a simple crosspiece. However, at the junction between the transverse portion 40a and the second section 38b, there is a thinned section 42a. This thinned section 42a is useful because, when the adult pushing the transporter 10 is moving at a relatively fast pace and their hand controlling the transporter 10 is placed centrally of the transverse portion 40a, the thinned section 42a can be positioned between the index and third fingers. This makes the control of the transporter 10 more comfortable.

The handle shown in FIG. 5(b) has a transverse portion 40b which includes two side grasping portions 46b and a central grasping portion 48b. The transverse portion 40b is shaped to allow the central grasping portion 48b to be free of any structure which will get in the way of the adult's hand, thus dispensing with any need for a thinned section in this embodiment. In use, the adult will grasp the side grasping portions 46b with both hands when pushing the child transporter 10 at walking pace and, when the pace is increased so that only one hand needs to be used to control the child transporter 10, the adult will grasp the central grasping portion 48b with one hand.

The handle shown in FIG. 5(c) has the advantage of being very easy to manufacture. The transverse portion 40c is formed integrally with the second section 38b of the handle 36. Furthermore, there is no central connection between the second section 38b and the transverse portion 40c. This means that the adult can move his or her hands to any desired position and also change from two hands to one hand without any difficulty.

FIG. 5(d) shows a configuration which provides the user with enlarged graspable end portions 50d at each end of the transverse portion 40d which provide additional ability to counter any tipping forces produced by the child.

Another feature of the child transporter 10 shown in FIGS. 1 to 4 which can be varied or adapted is the manner in which the handle 36 can be made detachable and/or collapsible. It must be understood that the handle 36 need not be detachable or collapsible at all but it is envisaged that some form or detachability and/or collapsibility is advantageous for transport and storage purposes.

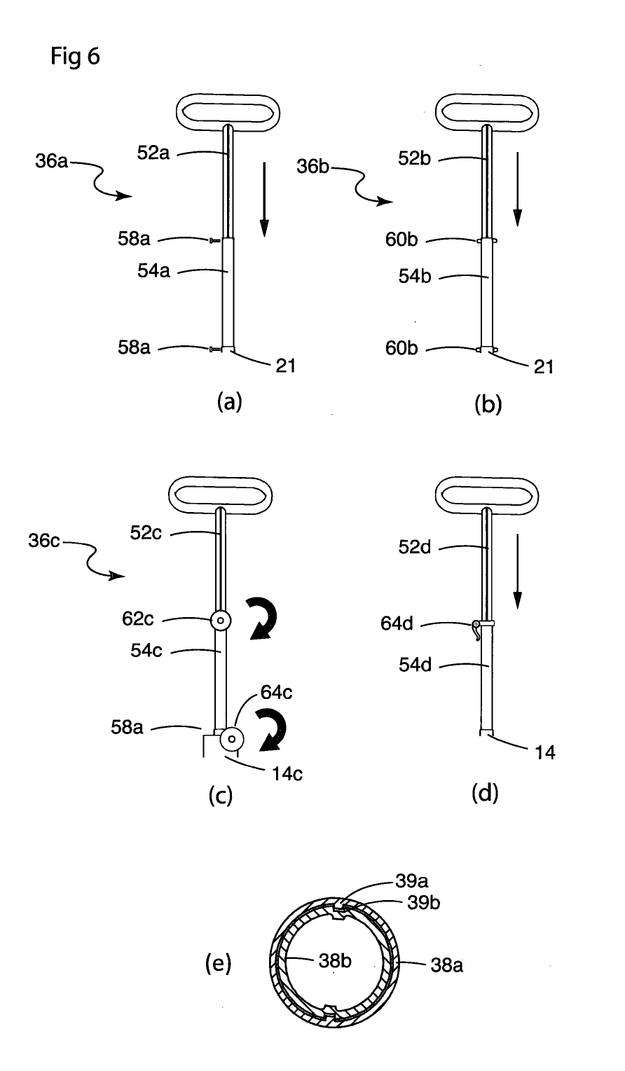

FIGS. 6(a) to 6(d) illustrate handles which could be used in place of the one shown in FIGS. 1 to 4. In FIG. 6(a), the handle 36a comprises two separate portions 52a, 54a which are able to slide telescopically inside one another. Screws 58a are provided to allow the separate portions 52a, 54a to be fixed in an extended position with respect to one another and also to fix the lower portion 54a to the neck 21 of the seat assembly 14. In another embodiment shown in FIG. 6(b), spring clips 60b are used in a manner similar to the screws 58a to allow the separate portions 52b, 54b of the handle 36b to telescope inside one another and to fix the handle 36b to neck 21.

FIG. 6(c) illustrates a handle 36c in which the separate portions 52c, 54c are joined by a rotatable joint 62c. This allows the upper portion 52c to fold down against the lower portion 54c once the rotatable joint 62c has been released. A similar rotatable joint 64c is provided between the lower portion 54c and the seat assembly 14c which allows the two portions 52c, 54c to fold down against the seat assembly 14.

Finally, FIG. 6(d) includes a fastener 64d similar to those often used to adjust the height of a bicycle saddle arranged between the separate portions 52d, 54d. Such a fastener allows the upper portion 52d to be fixed in an extended position with respect to the lower portion 54d, or released to allow telescopic sliding therebetween. A rotatable joint is also provided (but not shown) between the lower portion 54d and the seat assembly 14.

FIG. 6(e) illustrates a feature of each of the handles shown in FIGS. 6(a) to (d) and, indeed, the handle 36 shown in FIGS. 1 to 4. As can be seen in FIG. 6(e), each of the first sections 38a includes two longitudinally extending tongues 39a and each of the second sections 38b includes two longitudinal grooves 39b. The tongues 39a project into the grooves 39b and slide therewithin so that relative rotation between the first and second sections 38a, 38b about the longitudinal axis of the handle 36 is prevented.

Any and all of the arrangements described above would be advantageous from the point of view of allowing the child transporter described above to be stored and transported conveniently.

A further aspect of the child transporter 10 described in relation to FIGS. 1 to 4 which could be altered or adapted without departing from the scope of the invention is the handgrip 26 provided for the child to hold on to whilst riding on the child transporter. A selection of alternative designs for the handgrip are shown in FIGS. 7(a) to 7(d). The handgrip design shown in FIG. 7(b) is preferred because it requires the child to grip the handgrip at a point relatively close to the central axis of the transporter 10.

Keeping the child's arms and hands close to the central axis minimises the ability of the child to apply a tipping force to the transporter, which must be countered by the adult making use of the transporter. Other than that, none of the handgrips 26a, 26b, 26c, 26d shown in FIGS. 7(a) to 7(d) has any particular advantage over any of the other designs but the various designs are shown to illustrate that different designs are easily provided.

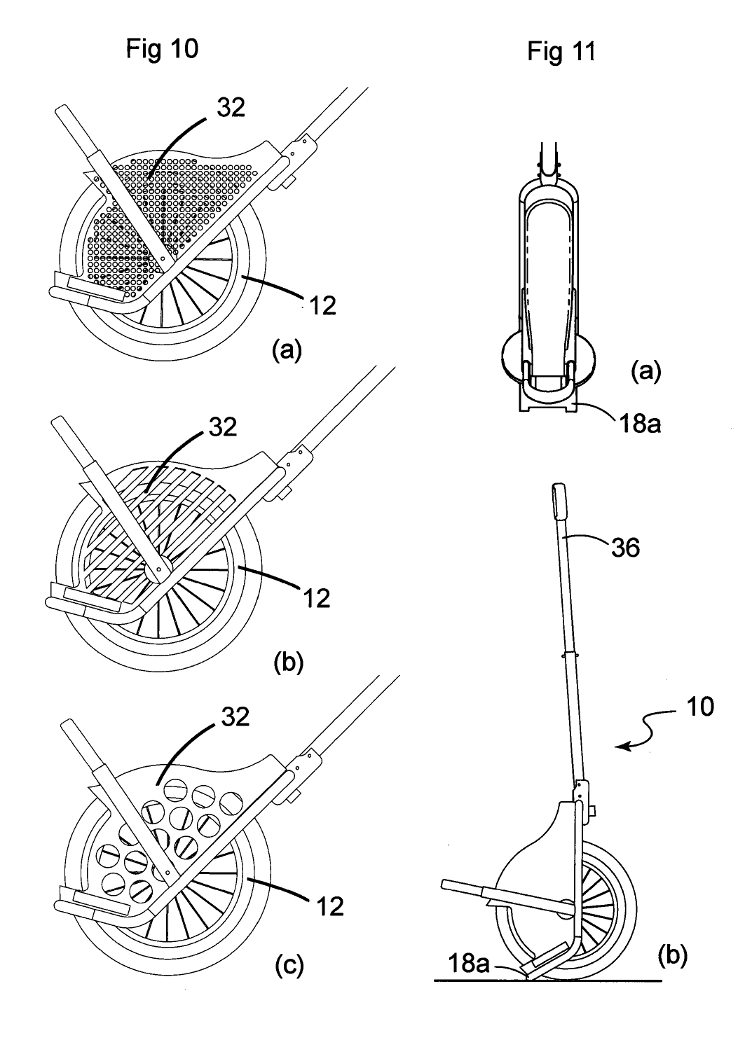

It is not necessary for the side panels 32 to be designed as shown in FIGS. 1 to 4. Variations on the design of the side panels 32 are shown in FIGS. 10(a) to 10(c). The aim of the side panels 32 is to allow a child to be transported on the child transporter 10 without any risk of the child's clothing becoming caught in the wheel 12. However, the side panels 32 can be of any suitable design. Providing openings in the side panels 32 reduces the weight of the side panels and also reduces manufacturing costs.

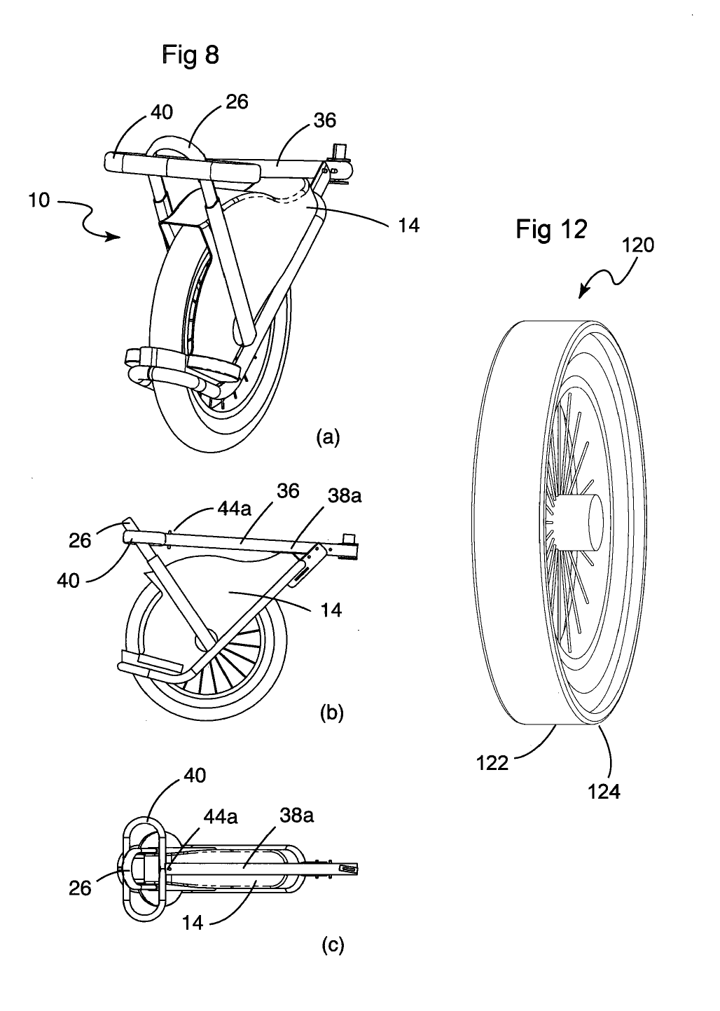

It has been mentioned that the handle 36 of the child transporter 10 can be used to provide a carrying handle for the child transporter 10. FIGS. 8(a) to (c) illustrate one way in which this can be achieved. The child transporter 10 is essentially as described with reference to FIGS. 1 to 4.

When the child transporter 10 is to be stored or itself transported, the handle 36 is rotated with respect to the seat assembly 14 by releasing the rotatable joint adjacent the seat assembly 14 to allow the handle 36 to be folded towards the hand grip 26. The sprung pins 44 are released to allow the second section 38b of the handle 36 to slide telescopically with respect to the first section 38a until the transverse portion 40 is looped over the handgrip 26. A second spring pin 44a is provided to hold the second section 38b in the correct position with respect to the first section 38a so that the handle 36 cannot move with respect to the handgrip 26. The shape of the handgrip 26 ensures that the handle 36 remains in a fixed relationship with the seat assembly 14. The handle 36 can then be used to transport the child transporter 10 as required.

Another embodiment of the child transporter is shown in FIGS. 11(a) and 11(b). In this embodiment, the child transporter 10 is essentially the same as the embodiment described above. The only difference is that the first U-shaped portion 18a in the latter embodiment has a generally square or rectangular shape so as to form a stand to allow the child transporter 10 to be supported in a generally upright position whilst not in use. This provides a convenient means of storage between periods of use. When the child transporter 10 is to be stored, the handle 36 is lifted into a substantially vertical position so that the first U-shaped portion 18a comes to rest on the floor or ground. The generally square or rectangular shape of the first U-shaped portion 18a provides a stand sufficient to prevent the child transporter 10 from toppling to one side or the other whilst not in use.

A further variation to the embodiments described above lies in the type of wheel which can be used in the child transporter 10. In the preceding paragraphs, it is envisaged that the wheel 12 will be of the type commonly used in apparatus used for transporting children such as children's scooters or bicycles. Such wheels may be rubber or inflated but will normally have a rounded profile as illustrated in FIGS. 1 to 4. In a further embodiment, the wheel 120 illustrated in FIG. 12 has a profile which includes a flattened section 122 as well as rounded edges 124. This type of wheel is not unknown and has been used in, for example, golf trolleys. When used in a child transporter 10 of the type described in detail above, the wheel 120 is less inclined to tilt to one side when the child transporter 10 is being pushed at relatively slow speeds. However, it is still possible to steer the child transporter 10 in along a curved or winding path without undue difficulty when the child transporter 10 is in use.

It is envisaged that the child transporter 10 could be manufactured from a variety of different materials. For example, the frame 16 and handle 36 may be manufactured from aluminium to provide strength and rigidity whilst being lightweight. Other materials may be used, including steel. The seat portion and side panels may be manufactured from a plastics material, although wood may also be used. The wheel may be aluminium or another metal such as steel, or may be wooden or plastic.

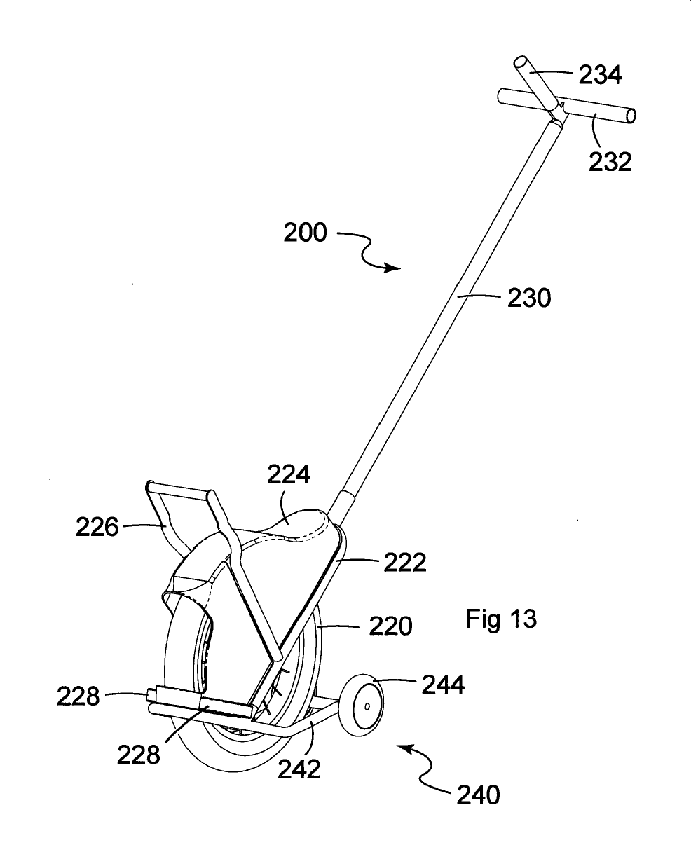

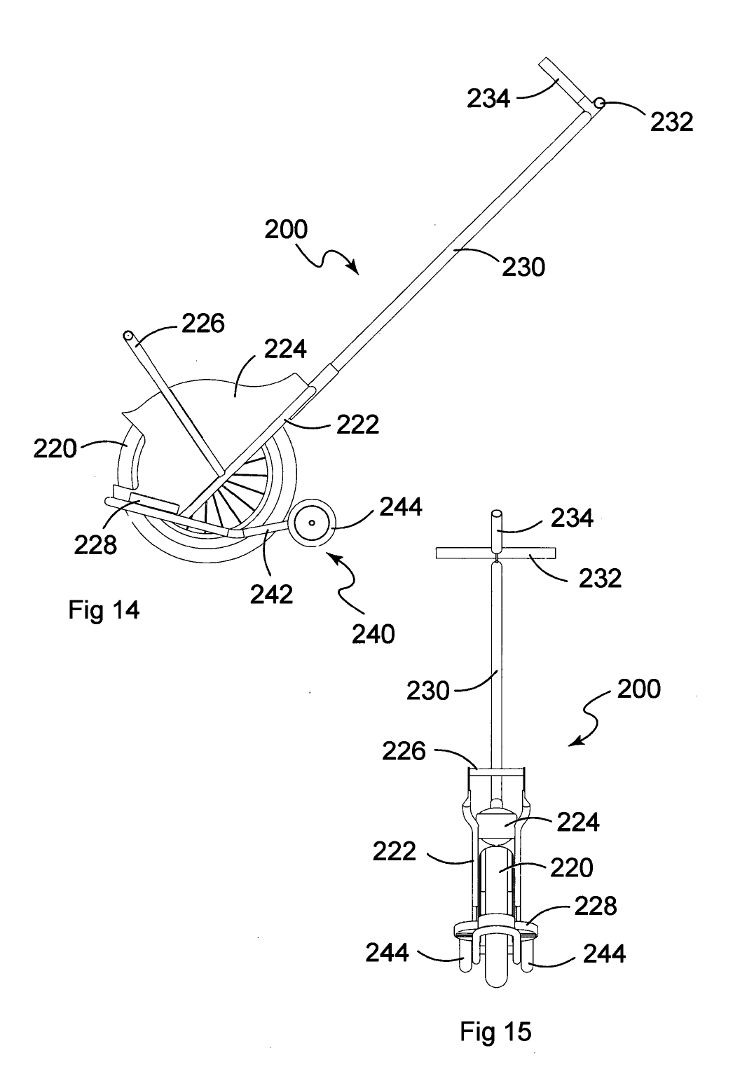

Turning now to the embodiment shown in FIGS. 13 to 16, the basic structure of the child transporter 200 is similar to that of the previous embodiments and described in detail above. A wheel 220 having an axle (not shown) is supported in a frame 222. The frame 222 supports a seat 224, a handgrip 226 and footrests 228. A handle 230 extends rearwardly and upwardly away from the frame 222 and includes a transverse portion 232. These basic elements can include any or all of the features described in detail above in relation to the previous embodiment.

The child transporter 200 includes two features not included in the first previous embodiment. First, the handle 230 includes, at its distal end, an upwardly extending grip portion 234 which also extends in a forwards direction, away from the adult in control of the child transporter 200. The grip portion 234 is here shown as a simple rod-shaped element but can be made any convenient shape for gripping by a user in the manner described below. The second feature not included in the first previous embodiment is the stabiliser 240. The stabiliser 240 consists of a generally U-shaped bracket 242 which is either connected to the frame 222 in the vicinity of the footrests 228 or may be integrally formed with the frame 222. The bracket 242 extends rearwardly so as to surround a lower, rearward portion of the wheel 220. The bracket 242 carries two stabilising wheels 244 which lie on a common axis lying behind the wheel 220. The stabilising wheels 244 are positioned so that they are spaced apart by a distance which is greater than the width of the wheel 220. This means that, when the stabilising wheels 244 are in contact with the ground, the points of contact of the wheel 220 and the stabilising wheels 244 form a triangle.

The stabiliser 240 is fixedly connected to the handle 230 via the frame 222. This means that, when the wheel 220 is in contact with the ground and the handle 230 is lifted away from the ground, the stabilising wheels 244 will also be lifted away from the ground. When the handle 230 is lowered towards the ground, the stabilising wheels 244 will be lowered towards the ground.

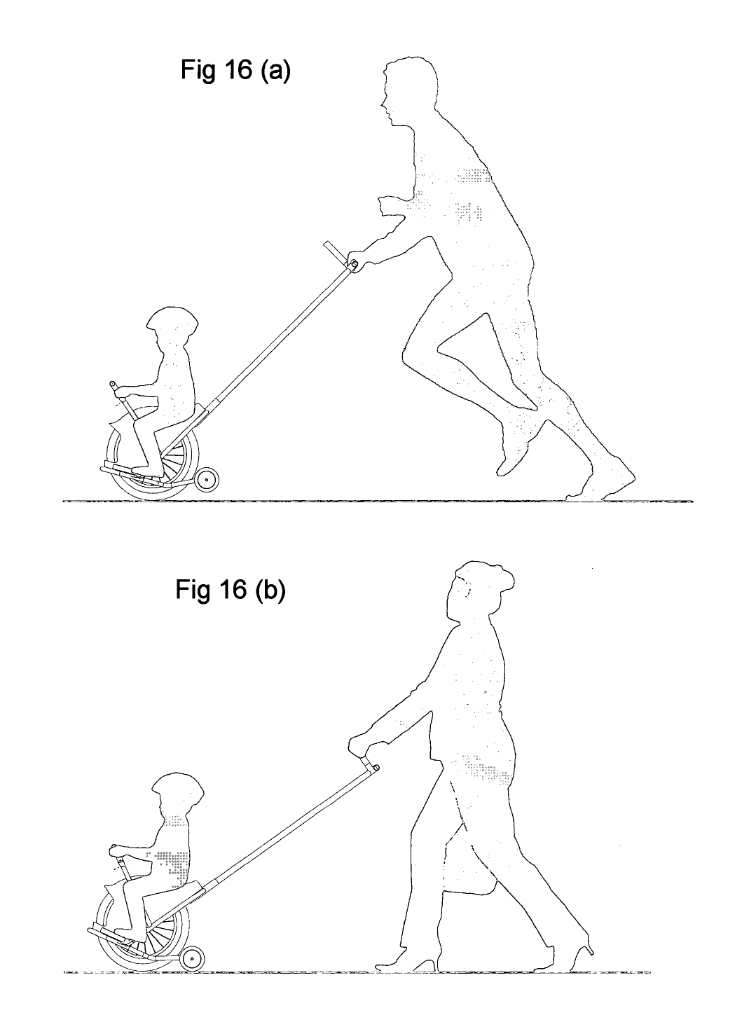

The child transporter 200 can be used in the following manner. When used at low speeds, and particularly on relatively smooth surfaces, the adult has the option to grasp the grip portion 234 rather than the transverse portion 232. Because the grip portion 234 is above the transverse portion 232, the natural position of the adult's hand will bring the distal end of the handle 230 into a relatively low position compared to the position in which it would be if the adult were to grasp the transverse portion 232. This will lower the stabiliser 240 and bring the stabilising wheels 244 into contact with the ground as shown in FIG. 16(b). The child transporter 200 is then supported on three wheels—the wheel 220 and the stabilising wheels 244—in a stable triangular formation. Lateral movements of the child being transported do not easily destabilise the child transporter 200. When the adult (or child) wants to move at faster speeds, all that is required is for the adult to transfer their grip to the transverse portion 232. This naturally raises the distal end of the handle 230 which lifts the stabilising wheels 244 away from the ground as shown in FIG. 16(a). The child transporter 200 then performs in the same way as the child transporter 10 described in detail above. The stabilising wheels 244 remain clear of the ground and are able to pass underneath the rear portion of the wheel 230 as the child transporter 200 is steered around obstacles or corners.

It is envisaged that the stabiliser 240 can be made detachable from the frame 222 simply by using sprung pins of the type described above or by any other readily available detachable connectors. It is also envisaged that the shape of the grip portion 234 could be varied from that shown and that the stabilising wheels 244 could be replaced by a single roller or other rolling support elements. The stabiliser 240 could, if required, be arranged to extend forwardly so that the stabilising wheels 244 were located underneath the footrests 228. In this instance, the grip portion 234 would be arranged to extend downwardly from the transverse portion 232 so that, in use, transferring one's grip from the transverse portion 232 to the grip portion 234 would lower the stabilising wheels 244 onto the ground.

The skilled reader will appreciate that the invention is not strictly limited to the details given in the above detailed description. Variations and alterations will be apparent to a skilled reader.

1. A child transporter comprising a wheel having an axle, a seat located directly above the wheel for supporting the child, at least one footrest for supporting the child's feet such that, in use, the child straddles the wheel, and a handle extending away from the wheel so as to be graspable by an adult.

2. The child transporter as claimed in claim 1, wherein the seat is located directly above the axle of the wheel.

3. The child transporter as claimed in claim 1, wherein, in use, the child's centre of gravity passes substantially through the axle of the wheel.

4. The child transporter as claimed in claim 1, wherein, in use, the wheel comprises the only point of contact with the ground.

5. The child transporter as claimed in claim 1, wherein the wheel has a diameter of between 250 mm and 500 mm.

6. The child transporter as claimed in claim 5, wherein the wheel has a diameter of between 300 mm and 400 mm.

7. The child transporter as claimed in claim 6, wherein the wheel has a diameter of substantially 350 mm.

8. The child transporter as claimed in claim 1, wherein the at least one footrest is moveable between a plurality of locations with respect to the seat.

9. The child transporter as claimed in claim 1, further comprising at least one handgrip graspable by the child, the at least one handgrip being located forward of the axle of the wheel.

10. The child transporter as claimed in claim 9, wherein the portion of the handgrip which, in use, is grasped by the child is proximate the central axis of the child transporter.

11. The child transporter as claimed in claim 10, wherein the portion of the handgrip which, in use, is grasped by the child does not extend laterally beyond the seat.

12. The child transporter as claimed in claim 1, wherein the handle has a first end and a second end, the first end being connected to the wheel and the second end being located remote from the wheel.

13. The child transporter as claimed in claim 12, wherein the second end of the handle comprises a longitudinal portion and a transverse portion.

14. The child transporter as claimed in claim 13, wherein the transverse portion lies at a distance of between 990 mm and 1300 mm from the central axis.

15. The child transporter as claimed in claim 14, wherein the transverse portion lies at a distance of substantially 1100 mm from the central axis.

16. The child transporter as claimed in claim 13, wherein the transverse portion extends laterally on either side of the longitudinal portion.

17. The child transporter as claimed in claim 16, wherein the handle includes a thinned section immediately adjacent the transverse portion.

18. The child transporter as claimed in claim 16, wherein the transverse portion has three grasping portions extending across the longitudinal portion.

19. The child transporter as claimed in claim 1, wherein the handle is detachable from the wheel.

20. The child transporter as claimed in claim 1, wherein the handle is collapsible and/or foldable.

21. The child transporter as claimed in claim 20, wherein, when the handle is in a collapsed or folded position, the handle forms a carrying handle for the child transporter.

22. The child transporter as claimed in claim 1, wherein side panels depend from the seat on either side of the wheel.

23. The child transporter as claimed in claim 1, further comprising a stand for supporting the child transporter in a generally upright position when not in use.

24. The child transporter as claimed in claim 1, wherein the wheel has a rounded profile.

25. The child transporter as claimed in claim 1, wherein the wheel has a profile which includes a flattened portion.

26. The child transporter as claimed in claim 1, further comprising at least one stabilising wheel, the at least one stabilising wheel being connected to the handle such that, in use, movement of the handle in a direction perpendicular to the ground determines whether or not the at least one stabilising wheel contacts the ground.

27. The child transporter as claimed in claim 26, wherein the at least one stabilising wheel is connected to the handle via structural members which support the seat, the at least one footrest, or both.

28. The child transporter as claimed in claim 26, wherein the at least one stabilising wheel is provided on a bracket extending rearwardly from the axle of the wheel.

29. The child transporter as claimed claim 26, wherein two stabilising wheels are provided.

30. The child transporter as claimed in claim 29, wherein the two stabilising wheels lie on a common axis which extends parallel to the axle of the wheel.

31. The child transporter as claimed in claim 29, wherein the stabilising wheels are spaced apart by a distance which is greater than the width of the wheel.

32. The child transporter as claimed in claim 26, wherein, in use, the stabilising wheels are lifted away from the ground when the handle is brought into a raised position and the stabilising wheels are brought into contact with the ground when the handle is brought into a lowered position.

33. The child transporter as claimed in claim 26, wherein the stabilising wheels are detachable from the rest of the child transporter.

34 (canceled)
